(19) United States
(12) Patent Application Publication
(10) Pub. No.: US 2013/0118746 A1
(43) Pub. Date: May 16, 2013

(54) Composite Cable Systems For Use In An In Situ Oil Production Process

(71) Applicant: Daniel Delp, Spring Grove, PA (US)

(72) Inventor: Daniel Delp, Spring Grove, PA (US)

(21) Appl. No.: 13/365,787

(22) Filed: Feb. 3, 2012

Related U.S. Application Data
(60) Provisional application No. 61/558,772, filed on Nov. 11, 2011.

(51) Int. Cl. E21B 43/24; H01R 43/00; E21B 43/00

(52) U.S. Cl. 166/302; 166/113; 166/60; 166/369; 29/825

(57) ABSTRACT

The present technology provides a system for delivering electrical power and fluid to a heater array system for use in an in situ oil production process. The system comprises multi-component composite cable having multiple conductors for delivering electrical power to a heater array, multiple hoses for transmitting fluid to a heater array, a strength member made of a heat resistant synthetic fiber material, and a cable jacket layer surrounding the conductors, hoses and strength member. The system also comprises multiple single-heater composite cables. The single-heater cables deliver electrical power and fluid from the multi-component composite cable to a heater in the heater array. A splice protector protects the connections between the multi-component composite cable and the multiple single-heater composite cables. Each of the single-heater composite cables is connected to at least one conductor and at least one hose of the multi-component cable within the splice protector.

### RELATED APPLICATIONS

This application makes reference to, and claims priority to U.S. Provisional Patent Application No. 61/558,772 filed on Nov. 11, 2011 by Daniel Delp, titled “Composite Cable Systems For Use In An In Situ Oil Production Process.” U.S. Provisional Patent Application No. 61/558,772 is hereby incorporated by reference in its entirety.

### BACKGROUND OF THE INVENTION

Oil has been used as an energy source for centuries. Extracting bitumen oil from the ground requires conversion of the solid hydrocarbons to liquid form, so that they can be pumped or processed. This is done by heating the bitumen to a high temperature, and separating and collecting the resultant liquid. This heating process is called retorting. Bitumen extraction (also referred to as oil extraction and oil production) is generally done in one of two ways: strip mining, and in situ processing.

Strip mining, or surface processing (also referred to as surface retorting), is a common method for extracting oil. Strip mining involves stripping of dirt and oil from the ground. Strip mining of oil can be done using traditional mining methods, either by open pit mining or underground mining (sometimes called room-and-pillar method). But strip mining has many disadvantages: strip mining methods have a large land impact and consume large amounts of water (as the process requires water for operations and also requires pumping out groundwater to prevent flooding of the mines). And this land impact can have an effect over a very long time period, spanning several decades. Additionally, strip mining involves a considerable land impact while room-and-pillar mining methods are considered inefficient: approximately one-third of the available oil resources are left behind in pillars and/or un-mined areas. In fact, the mining process becomes less efficient for thicker resources. Moreover, disposal of the waste shale is a major problem for some processes, requiring large quantities of water. Typically, strip mining allows for the extraction of bitumen that is present between the surface and a depth of about 40 meters below the surface of the earth.

In situ production is the technology for extracting the bitumen deposits while still underground. This process obviates the problems of mining, handling, and disposing of large quantities of material, which occur for above ground retorting. In situ processing also offers the ability to recover deposits of bitumen that are at depths much deeper than can be accessed through the strip mining process. In situ oil production methods may introduce solvent or thinning agents or alternatively may involve heating up or melting the very heavy oil, so the deposit is made flowable while still below the ground surface. In situ processing is suitable for reservoirs which are between 50 feet and 500 feet below the surface.

One in situ method for extracting bitumen involves injection of high pressure steam. In this method, steam, which can be added to a solvent, is injected at high pressure through a pipe running horizontally within the reservoir. The bitumen heated-up, melted or dissolved from the sand or rock seeps down to a second pipe through which the liquefied bitumen is extracted. However, this method tends to create high pressures underground, with the potential for a volcano effect, projecting boulders and other substances into the air above the surface of the earth. Therefore, for safety reasons, this high pressure steam method is only used to extract bitumen that is about 400 meters or further below the surface.

These two methods (strip mining and steam injection) allow for obtaining bitumen that is less than about 40 meters, or more than about 400 meters below the surface; however, up to 85% of the available bitumen exists between these levels. Another method involving the use of heaters buried in the bitumen can be an effective method to apply heat to the bitumen, getting the oil to flow and ease in the extraction. However, these buried heaters or heater arrays must still be supplied with power and fluid to keep the heaters operating. The installation of these buried heaters can be extremely difficult, as it can take weeks to install the heater array and the installation process itself can damage the wires and hoses. Since this damage can occur after the heaters and wire are below ground level, the damage only becomes apparent once the system is energized and the result of the damage is often a system failure due to shorted electrical conductors.

### BRIEF SUMMARY OF THE INVENTION

The present technology generally relates to a specialty composite cable system for supplying electrical power and fluids to a subterranean heater. More specifically, the present technology relates to a system employing a composite cable comprising electrical cables, fluidic hoses, and mechanical strength members for use in a method of extracting bitumen deposits.

Certain embodiments of the present technology present a composite cable for delivering electrical power and fluid to a heater array for use in an in situ oil production method. In certain embodiments, the composite cable comprises multiple conductors for delivering electrical power to a heater array that is suitable for use in an in situ oil processing method. Each of the conductors has a conductive wire (e.g., a tin plated copper line, wire, cable or conductor) surrounded by an insulation layer, and may comprise a conductor jacket and a fiberglass braid layer. The composite cable also comprises a plurality of hoses for transmitting fluid to the heater array. In certain embodiments, the composite cable comprises a strength member having a heat resistant material (e.g., a synthetic fiber material), and a strength member jacket. A cable jacket may surround the conductors, hoses and strength member. In certain embodiments, the composite cable comprises one strength member in the center of the cable, surrounded by three conductors and three hoses, alternated around the strength member.

Certain embodiments also relate to a single-heater composite cable for delivering electrical power and fluid to an individual heater of a heater array for use in an in situ oil production process. The single-heater composite cable comprises a conductor, which has a conductive wire surrounded by an insulation layer, and may comprise a conductor jacket layer and a fiberglass braid layer. The single-heater composite cable also comprises a hose for transmitting fluid to an in situ heater in an in situ heater array. The single-heater composite cable is also surrounded by a cable jacket layer that protects the electrical conductor wire and the hose. In certain embodiments, the single-heater composite cable is adapted to connect with a portion of a composite cable comprising a plurality of electrical conductor wires and a plurality of hoses, (e.g., a multi-composite cable as described herein) and to an individual heater. In certain embodiments, the single-heater composite cable is connected to an in situ heater that is part of an in situ heater array, and delivers fluid and electrical power from a multi-component composite cable to an individual heater.

Certain embodiments of the present technology provide a system for delivering electrical power and fluid to a heater array system for use in an in situ oil production process. The system comprises a multi-component composite cable, for example, the multi-component composite cable described above. The multi-component composite cable comprises multiple conductors for delivering electrical power to a heater array, multiple hoses for transmitting fluid to a heater array, a strength member made of a heat resistant material (e.g., a synthetic fiber material such as aramid fiber), and a cable jacket layer surrounding the conductors, hoses and strength member. In certain embodiments the system also comprises multiple single-heater composite cables. The single-heater cables deliver electrical power and fluid from the multi-component composite cable to a heater in the heater array. Each of the single-heater composite cables comprise an electrical conductor wire for delivering electrical power to a heater in the heater array, a hose for transmitting fluid to a heater array, and a cable jacket layer surrounding the electrical conductor wire and hose. The system also comprises a splice protector (also referred to in some embodiments as a “splice location” a “splice box” or a “splice unit”) for protecting the connection(s) between the multi-component composite cable and the multiple single-heater composite cables. The splice protector comprises a protective housing, and a protective substance within the housing. Each of the single-heater composite cables is connected to at least one conductor and at least one hose of the multi-component cable within the splice protector. The protective substance encases the connection between the single hose and the multi-component composite cable.

Certain embodiments also provide a method of providing electrical power and fluid to a multi-heater array. The method comprises providing a multi-component composite cable, wherein the multi-component composite cable has multiple electrical conductors, a plurality of hoses, a strength member comprising a heat resistant synthetic fiber material, and a jacket layer surrounding the conductors, hoses and strength member. The method also includes providing several single-heater composite cables that deliver electrical power and fluid (e.g., water) from the multi-composite cable to a heater in the heater array. Each of the single-heater composite cable can include an electrical conductor wire, a hose and a cable jacket layer. The method also includes the step of connecting each subcomponent of each single-unit composite cable with a corresponding component of the multi-component composite cable (e.g., connecting an electrical conductor of the single-heater cable with an electrical conductor of the multi-component composite cable and connecting a hose of the single-heater cable with a hose of the multi-component composite cable). Next, the method includes surrounding the connections between the cables with a protective housing, and filling the housing with a protective substance, for example, a silicone rubber substance. In certain embodiments, the method also includes the step of connecting the opposite end of each single-heater composite cable with a heater, wherein each single-heater cable connects to a separate heater that is a part of a heater array suitable for use in an in situ oil production process. The method also includes the steps of providing electrical power to one or more of the heaters, and providing one or more fluids through the hoses to one or more heaters.

Certain embodiments of the presently described technology also include a method for producing oil from subterranean bitumen deposits. The method comprises providing an in situ heater array comprising a plurality of in situ heaters. For example, the heater array may comprise three in situ heaters, arranged vertically. The method also includes providing a multi-component composite cable (i.e., a multi-heater composite cable). The multi-component composite cable may be a cable comprising multiple conductors, multiple hoses and a strength member as described herein. The method also provides multiple single-heater composite cables that deliver electrical power and fluid from the multi-component composite cable to an individual heater in the heater array. The single-heater composite cables may comprise a conductor and a hose surrounded by a jacket as described herein. Next, the method includes connecting a top portion of the electrical conductor wire of each of the single-heater composite cables with a bottom portion of a conductor of the multi-component composite cable; and connecting a top portion of the hose of each of the single-heater composite cables with a bottom portion of a hose of the multi-component composite cable. The connections between multi-component composite cable and the single-heater composite cables are then surrounded with a protective housing, and the housing is filled with a protective substance to protect the connections from exposure to the elements. A bottom portion of each single-heater composite cable is connected with an individual in situ heater in the heater array. Next, electrical power and fluid is provided to the first in situ heater in the heater array, liquid oil is collected from the bitumen deposit; and the liquid oil is transported from below ground to above ground.

### BRIEF DESCRIPTION OF SEVERAL VIEWS OF THE DRAWINGS

FIG. 1 depicts a schematic diagram of an in situ three-heater array system installed for use in an in situ oil production process.

FIG. 2 depicts a schematic diagram of an in situ three-heater array as used in the system of FIG. 1.

FIG. 3 depicts a cross section of a multi-component composite cable for use in an in situ oil production process in accordance with an embodiment of the present technology.

FIG. 4A depicts a cross section of a strength member of the multi-component composite cable of FIG. 3.

FIG. 4B depicts an alternate view of an embodiment of a strength member and a splice protector of the present technology.

FIG. 5A depicts a cross section of one conductor of the multi-component composite cable of FIG. 3.

FIG. 5B depicts an alternate view of the conductor of FIG. 5A.

FIG. 6 depicts a cross section of one hydraulic hose of the multi-component composite cable of FIG. 3.

FIG. 7 depicts an alternative schematic diagram of a portion of the in situ three-heater array system of FIG. 1.

FIG. 8A depicts a close up view of a splice protector in accordance with an embodiment of the present technology.

FIG. 8B depicts a partially transparent view of a splice protector in accordance with an embodiment of the present technology.

FIG. 9A demonstrates the internal connections within the splice protector depicted in FIG. 8.

FIG. 9B depicts an alternate view of the splice protector of FIG. 9A.

FIG. 10 depicts a cross section of a single-heater composite cable for use in an in situ oil production process in accordance with an embodiment of the present technology.

FIG. 11 depicts a schematic diagram of a portion of an embodiment of an in situ three-heater array system employing an intermediary strength member.

FIGS. 12A, 12B and 12C depict images of various stages in a method for installing an in situ three-heater array system in accordance with an embodiment of the present technology.

FIG. 13 depicts a demonstrative image of the connection of electrical conductors in accordance with an embodiment of the present technology.

### DETAILED DESCRIPTION OF THE INVENTION

The present technology generally relates to a composite cable system for supplying electrical power and fluid to a subterranean heater. More specifically, the present technology relates to a system employing a composite cable comprising electrical conductors, fluid hoses, and a mechanical support member to assist in extracting bitumen from oil shales. The present technology relates to a composite cable system that improves the ease and efficiency of installing a multiple heater array system for use in an in situ oil production process (also referred to as an “oil extraction” process).

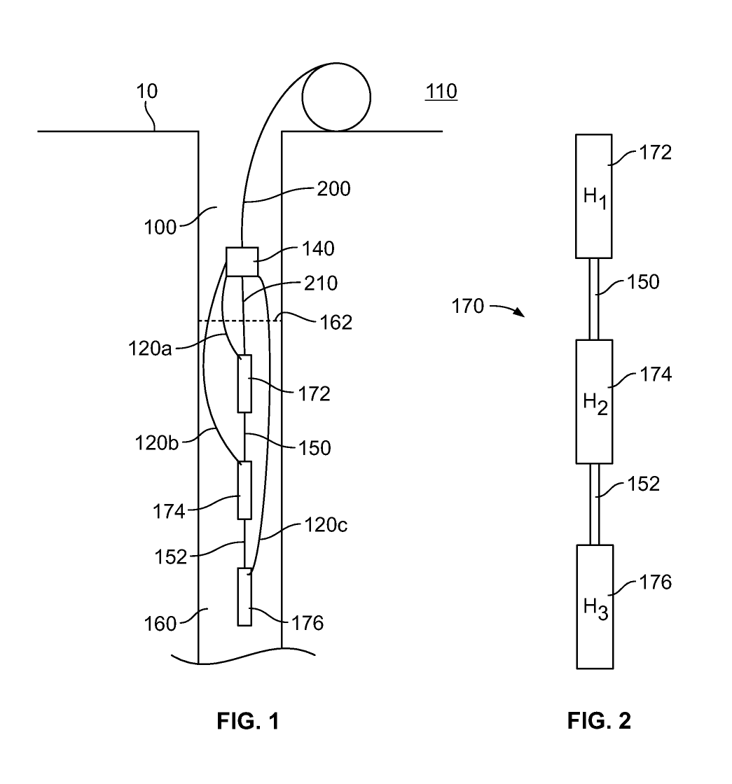

In one in situ oil processing technique, an array of multiple heaters are assembled, connected, and then installed underground to heat solid bitumen so that it will flow and facilitate oil extraction. While the number of heaters in a heater array can vary depending on the situation and the needs for the extraction process, it is common to employ the use of three heaters in an array. However, a heater array can comprise two, four, five, six or more heaters, depending upon the thickness of the bitumen deposit that is targeted for extraction. FIG. 1 depicts a schematic diagram of a three-heater array system installed in a well bore 100 as used in accordance with an embodiment of the present technology. Typically, the heaters (172, 724 and 176) are arranged in such a way that the heaters are aligned vertically, with approximately 15 feet between each of the heaters.

FIG. 2 depicts a schematic of a three-heater array 170, which may be used in the system of FIG. 1, for example. The heaters can be connected together by I-beams 150 and 152, or other weight-bearing connections, as demonstrated in FIG. 2, such that the entire heater array 170 can be moved collectively as a single unit. In FIG. 2, the top heater (“H1”) 172 is connected to the middle heater (“H2”) 174 by a first I-beam 150. The I-beam can be of any length depending on the circumstances for the particular in situ process, but a length of 15 feet to 18 feet is common. The middle heater 174 is then connected to the lower heater (“H3”) 176 by a second I-beam 152, which is typically the same length as the first I-beam. Accordingly, a typical three-heater array 170 can be of a standardized length, for example, 100 feet long.

In order to operate properly, each in situ heater of the in situ heater array 170 requires an electrical power source as well as a fluid source. Typically, the fluid delivered is water, which enables the heater to deliver its heat effectively to the bitumen. This is because the soil surrounding the in situ heater is not thermally conductive when it is dry. Dry soil serves as an thermal insulator, thereby negating or limiting the effects of the heater. Supplying water to the heater keeps the soil around the heater moist, and allows the heater to effectively warm and liquefy the solid bitumen. Additionally, the heater array may be provided with structural support to maintain its position at a constant depth below the surface of the earth.

Accordingly, each in situ heater is supplied with an electrical power source and a fluid source, and there must also be a strength member for supporting the weight of the system, which can result in six or seven different cables and wires running down the length of the well bore. Because these heaters are installed underground, sometimes at significant depths, previous methods of installing the heater array systems were difficult, time consuming, and subject to several complications. The present technology serves to alleviate many of these issues by providing a single composite cable that delivers three separate electrical power sources, three separate fluid sources, and a strength member that runs the majority of the length of the oil bore 100.

Referring again to FIG. 1, the top heater 172 of the heater array will typically be installed inside the well bore 100 at a certain depth below the bitumen 160. The distance between the surface of the earth 10 and the top surface of the bitumen 162 will vary for each well bore 100 depending on the geology and the bitumen of the particular oil bore. Typically, however the in situ heater array 170 can be installed such that the top heater 172 is at a standard depth below the surface of the bitumen, regardless of the depth of the well bore 100. For example, the top heater 172 can be installed approximately 30 to 40 feet below the top surface of the bitumen 162 regardless of whether the top of the bitumen 162 is 100 feet or 300 feet below the surface of the earth 10. Therefore the distance between the top of the bitumen 162 and each heater can be provided at a standard depth. For example, for a particular in situ oil production process, the distance between the top of the bitumen 162 and the top heater 172 of the heater array 170 can be standardized at 40 feet, for example. The distance between the top of the bitumen 162 and the second heater 174 can be standardized at 55 feet, for example. And the distance between the top of the bitumen 162 and the lower heater 176 can be standardized at 70 feet, for example.

Using standard or selected heater installation depths, the present technology therefore provides a package that can be easily installed onto a multiple-heater array based on a standard or adjustable distances between each heater and the top of the bitumen 152. For example, as shown in FIG. 1, a composite cable 200 comprises three separate electrical power wires, three separate hydraulic fluid hoses and a strength member, is provided. This composite cable 200 can be of a varying length depending on the depth of the bitumen 162 in the particular well bore. At a certain level above the bitumen surface 162, for example, 15 feet above the bitumen, the composite cable can be connected, at a splice protector 140 (i.e., a splice box, a splice location or a splice unit), to three individual cables (120a, 120b and 120c) that deliver electrical power and fluid to the individual heaters (172, 174 and 176), respectively.

Since the distance between the bitumen surface 162 and the in situ heaters can be standardized, the distance between the splice 140 and the bitumen 162 can also be standardized. Alternatively, the distances can be adjustable, so that in situ heaters can be installed at different depths so as to maximize the amount of oil extracted in a particular oil production process. Accordingly, the lengths of the individual cables can be provided in standardized or adjustable lengths that can be used for multiple heater array systems. For example, where the splice protector 140 is situated 15 feet above the bitumen, and the heater array is buried such that the top heater 172 is 40 feet below the bitumen surface 162, with 15 feet between each heater, then cable 120a can be provided at a standard length of 55 feet, cable 120b provided at a standard length of 70 feet, and cable 120c provided at a standard length of 85 feet. Additionally, the individual strength member 210 can be provided at a length of 55 feet such that the heater array 170 is supported in the bitumen. This standardized process allows for an installation system to be sold as a standard package that works for many or all well bores, regardless of the geology of the particular well bore, or how deep below the surface of the earth the bitumen is situated. In certain embodiments, the composite cable 200 can be provided on a drum 110 in a length sufficient to meet even the deepest well bores (e.g., 400 feet). When the cable 200 is provided on a drum 110, only the desired amount of cable 200 needs to be deployed down the well, and the unused length of the cable 200 can remain unwound on the drum 110.

Alternatively, the lengths of the individual cables can be provided in adjustable or extendable lengths so that the cables can be used in alternative in situ systems that may require installation of in situ heaters at varying depths and distances.

Using the present technology, the heater array system can be connected above the surface of the earth using a package having standard length cables, and subsequently lowered to the desired level in the well bore. The present technology, therefore, provides an easier method for installing a heater array, and significantly limits the number of different cables that are sent to deep lengths inside the well bore.

In certain embodiments, the present technology provides a multi-component (or multi-heater) composite cable comprising multiple electrical conductors (e.g., an electrical wire, line, cable or cord) and multiple fluid or hydraulic hoses. In certain embodiments, multiple separate single-heater composite cables are provided, where each single-heater composite cable comprises one electrical conductor wire and one fluid or hydraulic hose. A splice protector is also provided to protect the connections between the multi-component cable and the single-heater cables from exposure to the well bore environment. The number of electrical conductor wires and hydraulic hoses employed in the multi-component composite cable will depend on the number of heaters employed in the array used in the in situ oil producing system. For example, for an in situ oil processing system that employs three heaters, the multi-component composite cable may comprise three electrical conductor wires and three multiple hoses extruded together. Such a composite will be referred to hereafter as a “3/3 cable”. Additionally, the number of single-heater cables employed in a system will match the number of in situ heaters in the array. For example, a system that employs a 3/3 cable will typically use three single-heater cables (also referred to as a “1/1 cable”).

The present description will focus primarily on in situ processes that employ a heater array comprising three heaters. Accordingly, the composite cable system for the described processes may refer to the multi-component composite cable as a 3/3 cable, however it should be understood that composite cables comprising more fewer electrical conductor wires and hydraulic hoses can be used in different in situ processes. For example, depending on various circumstances, such as the geology of the oil bore, the temperature, the capabilities of the oil production equipment, and local ordinances, it may be desirable to employ more or fewer than three heaters in an array. Accordingly, for an in situ process involving 2, 4, 5, or 6 heater arrays, different sizes and types of composite cables would be employed, for example 2/2, 4/4, 5/5, or 6/6 composite cable can be employed respectively. However, the basic employment of the heater array system would remain the same. All the wires, hoses and strength members would be supplied together in a single composite cable down the majority of the length of the well bore up to a certain distance above the bitumen level. At this predetermined distance, the composite cable could then be split into the requisite number of individual cables based on the number of heaters in the array. Each heater will receive a single-heater cable comprising an electrical conductor wire and a hose. Because the distance from each heater to the splice protector can be a predetermined distance, each single-heater cable will be of an appropriate length to connect to the individual heaters.

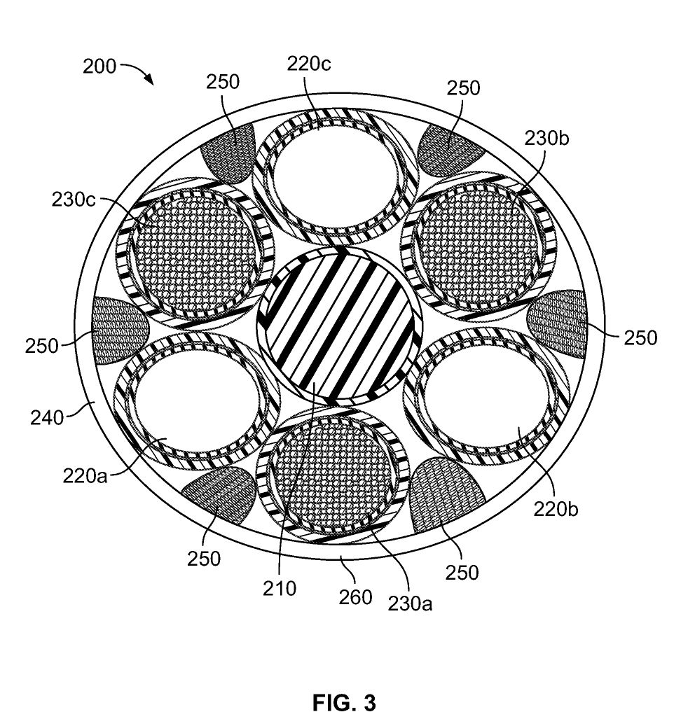

In a three heater array system, a multi-component (or multi-heater) composite cable delivers electrical power and fluid from above ground to the heater array buried below the ground in a well. The multi-component cable provides a plurality of conductors and hoses in one cable up to a splice protector. At a splice position, the composite cable is then split into, or connected to multiple single-heater cables, and covered by a splice protector. FIG. 3 depicts a cross-sectional view of a multi-component cable 200 (in particular, a 3/3 cable) in accordance with one embodiment of the present technology. In certain embodiments, the 3/3 multi-component cable 200 of FIG. 3 could be cable 200 from the embodiment of FIG. 1, and serve the same function in a similar heater array system. The cable can be manufactured with or without sealant inside the cable sufficient to make the cable water tight.

As depicted in FIG. 3, the multi-component cable comprises a strength member 210 for supporting the weight of the heating array system. The multi-component composite cable also comprises three electrical conductors (which may be lines wires, cords, cables, etc) (230a, 230b and 230c) for delivering electrical power to the heaters buried underground. Three hydraulic hoses (220a 220b and 220c) are also provided for delivering fluid (e.g., water) to the heaters. The cable is surrounded by a jacket 260 that encircles the entire cable. The jacket 20 can be manufactured by extruding a thermoplastic or thermoset material around the cable. The jacket 260 protects the wires and hoses of the composite cable from physical abuse during the installation process and during operation.

In certain embodiments, the multi-component cable 200 may be exposed to elevated temperatures for extended periods. Accordingly, the jacket 260 can be made of a thermoplastic material such as extruded fluorinated ethylene propylene (FEP). In locations where the temperature will not exceed 100° C., or in locations where the integrity of the jacket is of no concern after the cable has been deployed, a material such as chlorinated polyethylene (CPE) is suitable. The thickness of the jacket 260 can vary depending on the circumstances for the in situ oil production process, however a jacket wall thickness of 0.210 inches is suitable for many applications utilizing 3/3 cables. If it is anticipated that the multi-component cable will be exposed to higher or lower levels of heat, then a thicker or thinner layer could be employed as desired or required.

In certain embodiments, fillers 250 can be employed as desired to maintain a firm, round core or a cable of another shape or level of firmness. The fillers serve to keep the cable in a desired shape (e.g., round), as well as to resist the cable from being able to draw water should the cable be exposed to pressurized water. For example, if the composite cable has a significant amount of empty space inside the cable, the cable could act like a straw if exposed to pressurized water and draw water up through the interior of the cable. The use of fillers 250 reduce the amount of empty space between the internal components and can prevent or minimize the multi-component cable's ability to draw in water. In certain embodiments, the fillers are comprised of a compressed paper material or a cardboard. In certain embodiments, the composite cable has an interior, and the interior has essentially no empty space, or is substantially full of material.

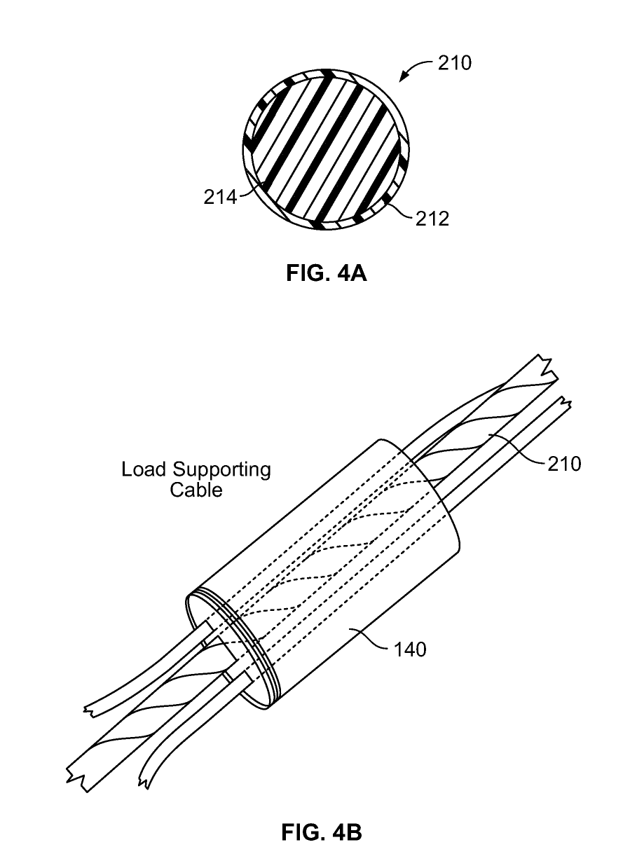

A close up view of a cross section of the strength member 210 is depicted in FIG. 4A. The strength member may comprise an aramid fiber rope material 214 at the core, surrounded by a strength member jacket 212. The strength member jacket 212 can be of the same material, and serves a similar purpose as the jacket 260 of the multi-component cable 200. The jacket 212 also serves to increase the width of the strength member 210 to fill out the space within the composite cable 200. Preferably, the fiber rope is of a material that is capable of resisting heat. For example, the fiber rope 214 can be an aramid fiber rope. More specifically, the fiber rope 214 can be poly-paraphenylene terephthalamide (i.e., Kevlar), Technora, Twaron or Heracron, for example. The thickness of the fiber rope 214 can vary, but a diameter of 0.500 inches is suitable for many embodiments utilizing a 3/3 cable. Similarly, the strength member jacket 212 can also vary in thickness. For example, a 3/3 composite cable may employ a strength member 210 with a strength member jacket 212 having a 0.100 inch wall thickness. Accordingly, in certain embodiments, a 3/3 cable may provide a strength member that has an overall diameter of 0.700 inches +/−0.020 inches, including the diameter of the fiber rope 213 and the thickness of the jacket 212.

The strength member 210 can bear the weight of the heater array system during the installation process, and while the system is in use. Alternatively, other weight bearing connections can be disposed between in situ heaters, either for primary weight-bearing purposes, or as a backup for the strength member 210. As depicted in FIG. 1, the strength member 210 is separated from the multi-component cable at the splice protector 140, and is connected to a top portion of the first in situ heater 172 of the in situ heater array. Alternately, the length of the strength member 210 extends beyond the end of the other components of the cable 200 so as to allow for attachment to the in situ heater array. In certain embodiments, the end of the strength member 210 may be equipped with a loop, hook (e.g., a caribeaner), chain or shackle to provide a method for attaching to the heater array 170, and in particular, the top surface of the top heater 172, which could be equipped with a corresponding structure such as a mating structure. In certain embodiments, a three-heater array can weigh in excess of 2500 lbs. Preferably, the strength member 210 is capable of supporting weights in excess of 2500 lbs, alternatively in excess of 5000 lbs.

FIG. 4B depicts a view of the strength member 210 relative to the splice location 140, as used in accordance with an embodiment of the present technology. As depicted in FIG. 4B, the strength member 210 passes through the splice location 140 independent of the other components of the cable 200.

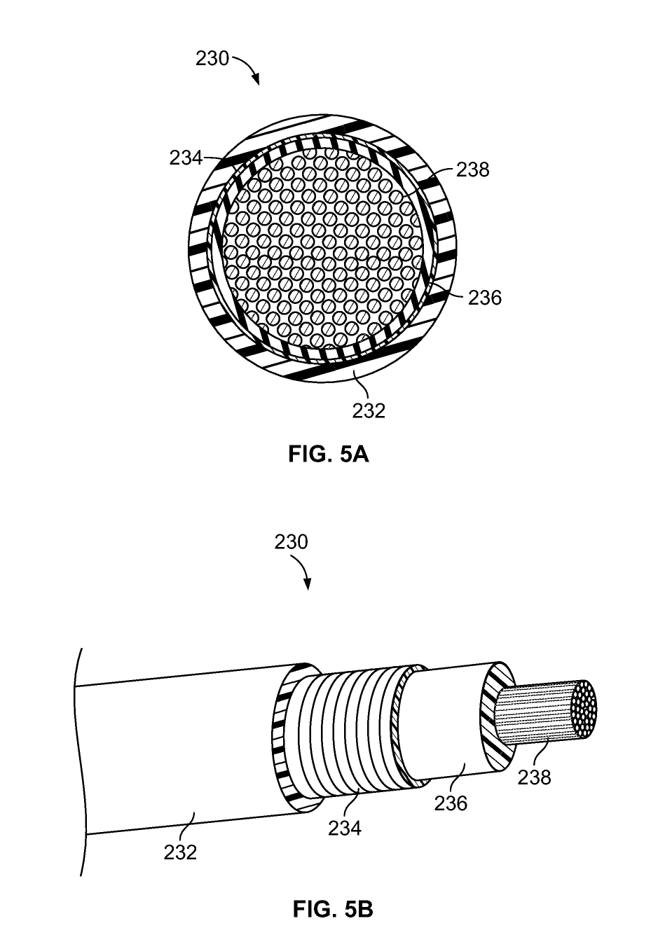

The 3/3 cable of FIG. 3 also depicts three electrical conductors 230a, 230b and 230c. A close up view of an electrical conductor 230 of a multi-component is depicted in FIGS. 5A and 5B. FIG. 5A depicts a cross section of the conductor 230, while FIG. 5B depicts an alternative three-dimensional side view of the electrical conductor 230 with each of the layers of the conductor 230 stripped back from the layer underneath. The electrical conductor 230 comprises a conductive metal wire 238 at the core for conducting electricity. The wire 238 can be comprised of tin plated copper or other materials suitable for conducting electricity. While various wire diameters can be employed, a wire diameter of 1/0 (one aught) is suitable for many in situ applications utilizing a 3/3 cable. The wire 238 of FIG. 5 is depicted as a stranded (259 strand) rope construction wire, however the present technology could employ various other stranded or solid wires, depending on the application.

Surrounding the wire 238 is an insulation layer 236. The insulation layer 236 can comprise a silicone rubber, for example, to withstand extremely high temperatures. While the thickness of the insulation wire layer 236 can vary, a wall thickness of 0.085 inches is suitable for many applications utilizing a 3/3 cable, including those employing a 1/0 tin plated copper wire layer 238.

In certain embodiments of the present technology, the insulation layer 236 is surrounded by a heat-resistant layer, such as a fiberglass braid layer 234. The fiberglass braid layer 234 assists the conductor 230 to withstand a high temperature. The fiberglass braid layer 234 also provides mechanical strength to the conductor, and allows the wire to maintain circuit integrity in the occurrence of extreme conditions, for example, if the conductor 230 is exposed to flame or fire. The fiberglass braid layer 234 can be died to a specific color as desired to assist a user in making connections to corresponding electrical conductor wires. In certain embodiments, the fiberglass braid layer 234 can be finished with a high temperature saturant such as lacquer.

In certain embodiments of the present technology, the conductor 230 also comprises a subjacket layer 232 surrounding the fiberglass layer 234. The subjacket 232 may be, for example, an extruded fluorinated ethylene polypropylene (FEP). The subjacket 232 is designed to protect the insulation layer 236 from contacting oil and other contaminants that could affect the integrity of the insulation material. In certain embodiments, the thickness of the subjacket can be 0.035 inches, for example, though various thicknesses can be employed depending on the circumstances for the application and the geometry of the other materials of the multi-component cable.

The electrical conductor wire as described herein can be capable of delivering electrical current through the multi-component cable. While the amount of electrical current necessary for delivery may vary based on the applications, an electrical conductor capable of withstanding operating at temperatures up to 200° C. and capable of delivering 600 volts would be suitable for many applications.

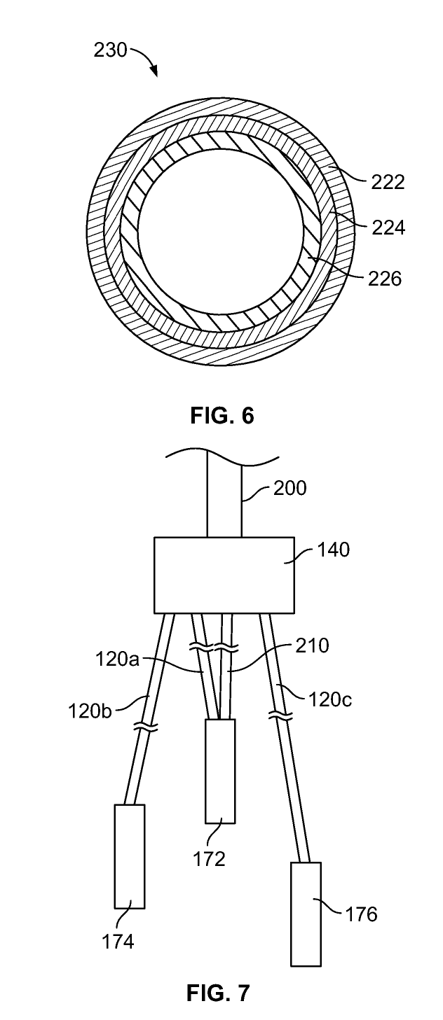

The multi-component composite cable 200 also comprises three fluid hoses 220. A close up view of one hose 220 is depicted in FIG. 6. In certain embodiments, the hose can be an electrically non-conductive hose with an internal diameter of ⅜ of an inch or ½ of an inch, and is rated for a pressure of at least 2250 PSI. In certain embodiments, the hose 220 can be an industry standard hose, for example, an SAE 100 R7 hose. The hose 220 may comprise an outer jacket 222, a braid layer 224, and an inner layer 226, though the structure of the hose can vary depending on the particular application.

Referring again to FIG. 3, the electrical conductors 230 and the hoses 220 can be arranged alternatingly around the strength member 210 in the multi-component cable. In certain embodiments, each hose 220 can be a different color, and the outer layer of each electrical conductor 230 can also be a different color. Using alternating colors can assist a user in identifying the proper wire, hose and/or connector to use for connection purposes during the installation process.

FIG. 7 depicts a schematic diagram of a portion of the in situ three-heater array system 100 of FIG. 1. Notably, FIG. 7 depicts a schematic diagram of the splice protector 140 of the system 100. As shown in FIG. 7, the multi-component cable 200 enters the splice protector 140 (or splice box) on one side, and four separate components emerge out on the opposite side of the splice protector 140. Three of the four components (120a, 120b and 120c) represent single-heater cables that are delivered to each of the three heaters (170, 172 and 174) of a three-heater array, while the fourth component is the strength member 210, which connects to the top heater 172 of the in situ heater array. Inside the splice protector 140, the components of the multi-component cable (i.e., the conductor wires, hoses and strength members) extend beyond the end of the multi-component composite cable 200. The ends of the conductor wires 220 and hoses 220 of the multi-component cable 200 are connected to corresponding ends of the individual single-heater cables (120a, 120b and 120c) so that the single-heater cables can deliver electrical power and transmit fluid through the multi-component cable 200 to the respective heaters of the heater array.

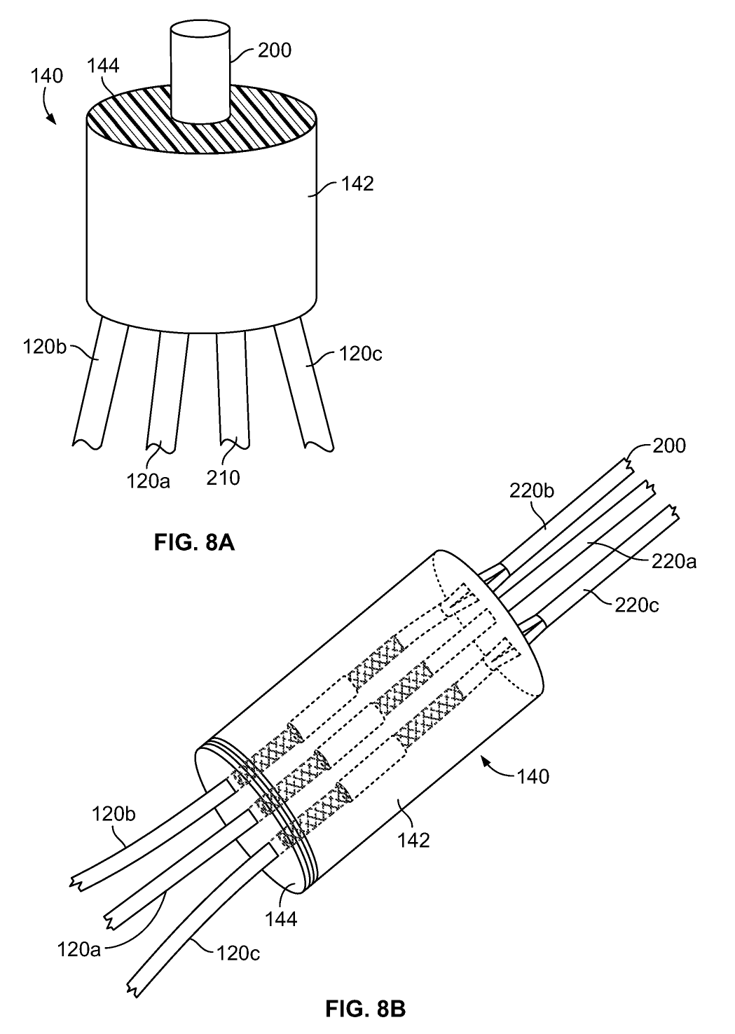

FIG. 8A depicts an alternate, isometric view of one embodiment of a splice protector 140 of the present technology. FIG. 8B depicts a translucent view of the splice protector showing the internal connections within the splice protector. As depicted in FIG. 8A, the splice protector 140 may comprise a protective housing 142, which may be a portion of a pipe. For example, the housing 142 may be a cylindrical PVC pipe four inches in diameter. Inside the housing 142, the individual conductor wires 230 and hoses 220 are connected to corresponding conductor wires and hoses of the three individual single-heater cables (120a, 120b and 120c), and the strength member 210 extends alone beyond the end of the multi-component cable 200. The three single-heater cables (120a, 120b and 120c) and the strength member 210 emerge from the opposite side of the housing 142 and connect to the respective heaters of the heater array. To protect the connections between the cables from exposure to the elements, the splice housing 142 is then filled with a substance 144 that is poured into the housing 142. The substance 144 can be a silicone rubber substance that solidifies and cures after being poured into the housing 142. The substance 144 serves to encase and protect all of the electrical and hydraulic connections within the splice protector 140. In certain embodiments, substance 144 can be a binary material that comprises both the sealant (e.g., a silicone rubber) and a hardener.

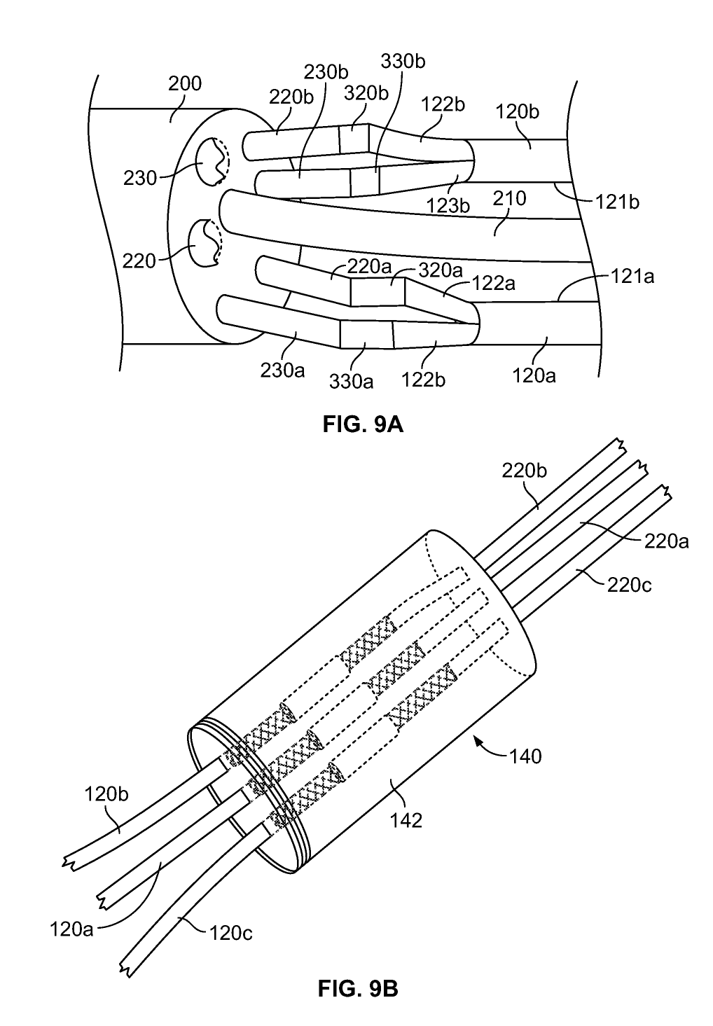

FIG. 9A depicts an isometric view of the internal structure of the splice protector 140. FIG. 9A is provided for demonstrative purposes, and for clarity, some of the cables are therefore not depicted in FIG. 9A. However in the present technology, it should be understood that each conductor wire, hose and strength member should extend through and beyond the end of the multi-component composite cable 200 within splice protector 140. FIG. 9B depicts a translucent view of the splice protector of FIG. 9A, which depicts the internal connections within the splice protector.

In FIG. 9A, electrical conductor wires 230a and 230b of the multi-component cable 200 are shown connecting to corresponding conductor wires 123a and 123b, which are a part of the individual single-heater wires (120a and 120b). The electrical conductors are connected via an electrical connector (330a and 330b). The electrical connectors (330a and 330b) may be a crimp connection, a quick connector that allows for a snap-fit type of connection, or other methods generally known for connecting electrical wires. Similarly, the hoses 220a and 220b of the multi-component cable 200 are connected to individual hoses 122a and 122b of the single-heater cables (120a and 120b) via a fluid or hydraulic connector (320a and 320b). The fluid or hydraulic connectors 320a and 320b can also be snap fit quick connectors, crimped connections, or other methods generally known for connecting fluid or hydraulic hoses.

In certain embodiments the hose 220a will be of a similar or identical color to hose 122a to help an assembler easily identify the proper hose for connection purposes. Similarly, hose 220b can be of a similar or identical color to the corresponding hose 122b, and the electrical conductors 230a and 230b can be of similar or identical colors to the corresponding wires 123a and 123b of the single-heater cables.

Moving to the right in FIG. 9A, the hose 122a and electrical conductor 123a merge together into an individual single-heater cable 120a, and are encased by a single-heater cable jacket layer 121a. Similarly, hose 122b and conductor wire 123b merge into single-heater cable 120b and are encased by a single-heater cable jacket 121b. Each single-heater cable (120a and 120b, and 120c (not shown)) emerges from the splice protector 140 and connects with the respective in situ heaters of the in situ heater array to provide the in situ heaters with electrical power and fluid supply. The strength member 210 also emerges from the splice protector to connect to the top heater of the heater array, thereby supporting the weight of the heater array assembly.

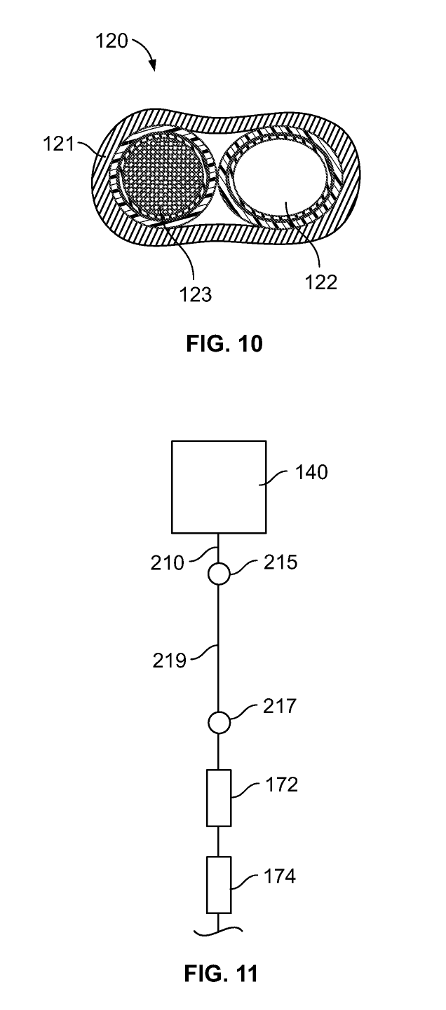

FIG. 10 depicts a cross sectional diagram of an exemplary single-heater cable used in accordance with the present technology. As shown, the single-heater cable 120 comprises a jacket 121, which may be of a similar or identical material to the jacket 260 (see FIG. 3) of the multi-component cable. Inside each single-heater cable is an electrical conductor wire 123 which has a similar or identical structure to the electrical conductor wires 230 (see FIG. 3) of the multi-component cable. Namely, the electrical conductor 123 can comprise a wire comprising 1/0 (259 strand) copper wire, an insulation layer, a fiberglass braid layer and a subjacket as described above in connection with the electrical conductor 230 of FIG. 5. Similarly, the hose 122 can have a similar or identical structure to the hoses 220 (see FIG. 3) of the multi-component cable. Namely, the hose 122 can be a ⅜ inch hose that is rated for 2250 PSI. In certain embodiments, the hose 122 can be an industry standard hose, for example, an SAE 100 R7 hose.

FIG. 11 depicts a schematic diagram of a portion of one embodiment of a three-heater array system of the present technology. As depicted, a connector 215 (e.g., a shackle) is attached to the end of strength member 210 after the strength member emerges from the splice protector 140. An intermediary strength member 219 is connected to the connector 215 at a top end, and to another connector 217 at a bottom end. Intermediary strength member 219 may be comprised of the same or similar components as strength member 210. At the connector 217, which may be a shackle, for example, the intermediary strength member 219 connects to the top heater 172 of the in situ heater array of the system. Use of an intermediary strength member allows for the heater array to be lowered into the well bore by a crane, and then connected to the bottom of the strength member 210, thereby allowing the load bearing the in situ heater array to be transferred from a crane to a cable (e.g., cable 200 of FIG. 1) and drum (e.g., drum 110 of FIG. 1), and then lowered to the required depth.

In certain embodiments, the multi-component composite cable comprises three electrical conductor wires and three fluid or hydraulic hoses (e.g., a 3/3 cable), however, the present technology is not intended to be limited to such 3/3 cables. For example, certain embodiments may employ a composite cable that employ single-heater cables, wherein each of the single-heater cables delivers electrical power and fluid to a separate in situ heater suitable for use in in situ oil production. In certain embodiments, the multi-component cable delivers electrical power and fluid from the surface of the earth to a splice protector, situated underground in an well bore. The multi-component cable comprises multiple electrical conductors and multiple fluid or hydraulic hoses. At the splice protector, the multi-component cable is split into multiple individual single-heater cables, each single-heater cable comprising one electrical conductor wire and one hydraulic hose.

Using the presently described technology, an improved in situ oil production method is provided. Additionally, the present technology provides an improved method for installing a heater array system for use in in situ oil processing systems is provided. The installation method comprises providing a multi-component composite cable wound on a drum, for example a 72 inch drum (e.g., drum 110 shown in FIG. 1). The cable may have multiple electrical conductors, multiple fluid or hydraulic hoses, and at least one strength member, as described herein. The cable may be provided in various lengths, but a length of 400 feet can be suitable for deeper in situ oil production processes. In certain embodiments, a length of the multi-component composite cable is inserted into the center of the drum before the multi-component composite cable is wound on the drum. This allows for the end portion of the multi-component composite cable to remain readily accessible to users no matter how much of the multi-component composite cable remains wound or unwound on the drum. Accordingly, a user may connect the end of the multi-component composite cable to a power and fluid supply after the system has been installed. This connection process can involve, for example, attaching connectors to the end of the individual conductors and hoses on the multi-component composite cable and using the connectors to attach to a source. For identification purposes, the end portion of the multi-component composite cable that remains within the drum shall be hereinafter referred to as the “top” end, whereas the portion of the multi-component composite cable that connects to the in situ heater array shall be referred to as the “bottom” end of the multi-component composite cable.

In certain embodiments, the bottom end of the multi-component composite cable is then attached to the individual single-heater cables. This may be accomplished by providing a portion of each of the individual components of the multi-component composite cable extended beyond the end of the jacket of the multi-component composite cable. For example, in a three-heater in situ oil production process, a multi-component cable may comprise three conductors and three hoses. Each of the three conductors may extend out beyond the jacket of the multi-component composite cable and may comprise a connector on the end of the conductor. Similarly, each of the hoses of the multi-component composite cable may extend beyond the end of the jacket layer and also be equipped with hoses on the end. These individual conductors and hoses may then be connected to corresponding mating portions on a corresponding single-heater cable. In certain embodiments, the conductors and hoses of the multi-component composite cable may be color-coded to assist a user in assembly. For example, in a three-heater array system, the hose and conductor of one single-heater cable may be red in color, one may be green, and one may be yellow. The corresponding hoses and conductors in the multi-component composite cable may similarly be colored red, green and yellow, respectively, indicating that the red hose of the multi-component composite cable be connected to the hose of the red single-heater cable, and so on. In certain embodiments, each of the single-heater cables themselves may be color coded in addition to, or instead of the individual conductor and hose components.

The strength member of the multi-component composite cable may also extend beyond the end of the jacket layer, and be equipped with a connection mechanism allowing for connection to a heater array. For example, the end of the strength member may be equipped with a hook (e.g., a carabineer), a loop, a shackle, or a threaded portion that allows the strength member to connect with a corresponding portion situated on the top of the heater array, and allowing the strength member to support the weight of the heater array.

After the connections are made between the multi-component composite cable and the single-heater cables, a protective housing may be placed over the area of the connections. The housing may be a cylindrical PVC pipe, for example, or another structure as described above in conjunction with the description of the splice protector 140 of FIG. 7, for example. Once the housing is in place, the housing is filled with a protective substance. For example, the housing may be filled with a heated silicone rubber material that solidifies over the connections enclosed in the housing as it cools. The filled housing, or the splice protector, therefore provides a location where the multi-component composite cable is safely connected to each of the individual single-heater cables without risking exposure to the environment, and where the strength member of the multi-component composite cable extends beyond the splice protector to attach to the heater array.

Next, the single-heater cables can each be connected to an individual heater of a heater array. For example, in a three-heater array system, a 3/3 composite cable will be connected to each of three separate 1/1 cables at a splice protector, and each 1/1 cable will in turn be connected to an appropriate heater of the heater array. The 1/1 cables may vary in length, such that the 1/1 cable that is connected to the top heater is shorter than the 1/1 cable connected to the middle heater, which is shorter than the 1/1 cable connected to the bottom heater. The three in situ heaters in the array may be connected to each other by an I-beam, for example, or another load bearing connection mechanism. The connection portion on the end of the strength member is then connected to the top of the in situ heater array, which may comprise a hook or a loop on the top of the top heater of the heater array, for example.

Once the connections are made, the heater array system is then lowered into a well bore until the heaters are sufficiently buried in the bitumen. Accordingly, the present methods can include drilling or otherwise forming a well bore that extends through a bitumen deposit. The heater array system may be lowered by a crane, for example, or another method for lowering heavy equipment into a deep well or hole. In certain instances, the connections and lowering of the heater array should be done within a limited amount of time, depending on geological conditions within the well bore and other environmental factors. After the heater array is in the appropriate position, the top end of the multi-component composite cable can be connected to the power and fluid source, and the in situ oil production process can begin. The process can include heating the bitumen, collecting liquid oil, and transporting the liquid oil from below the ground to above the ground.

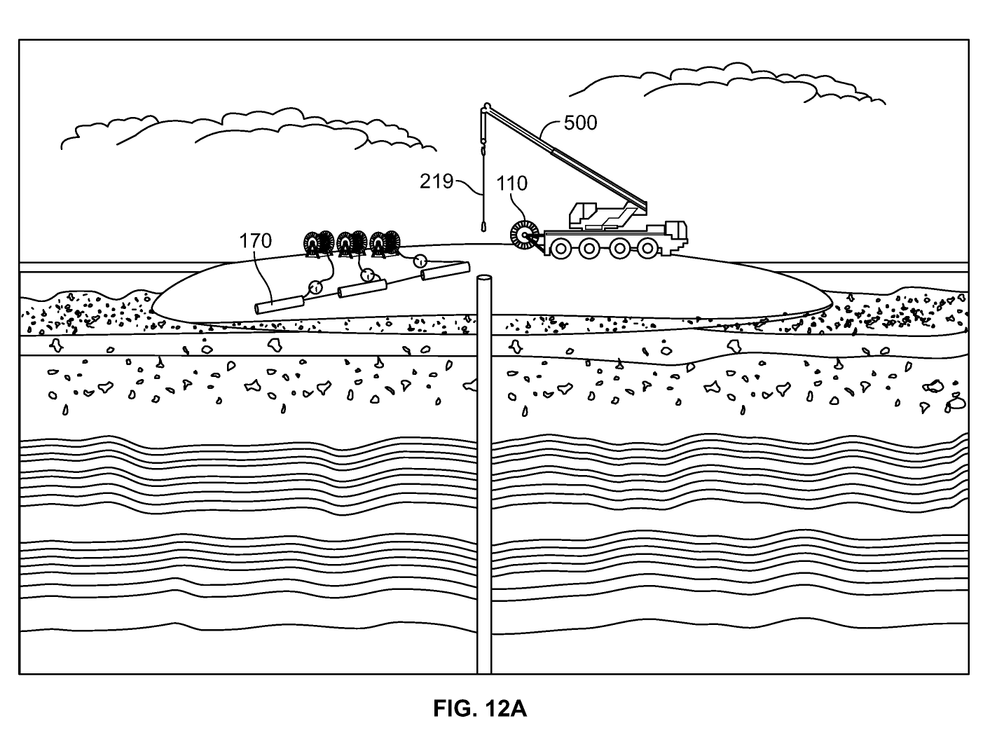

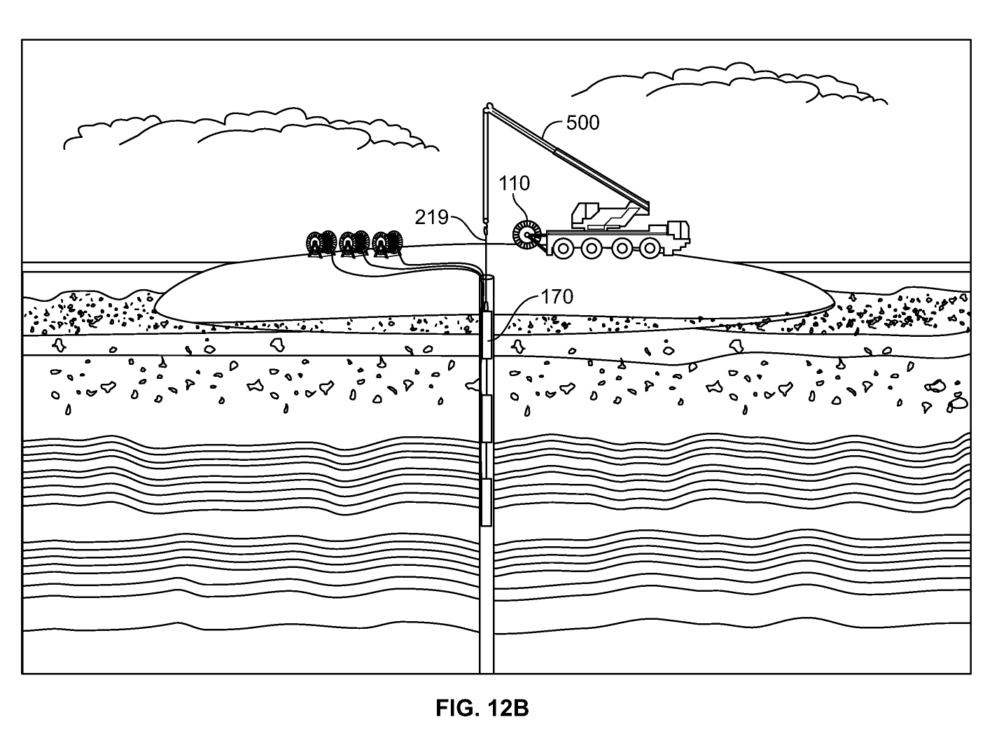

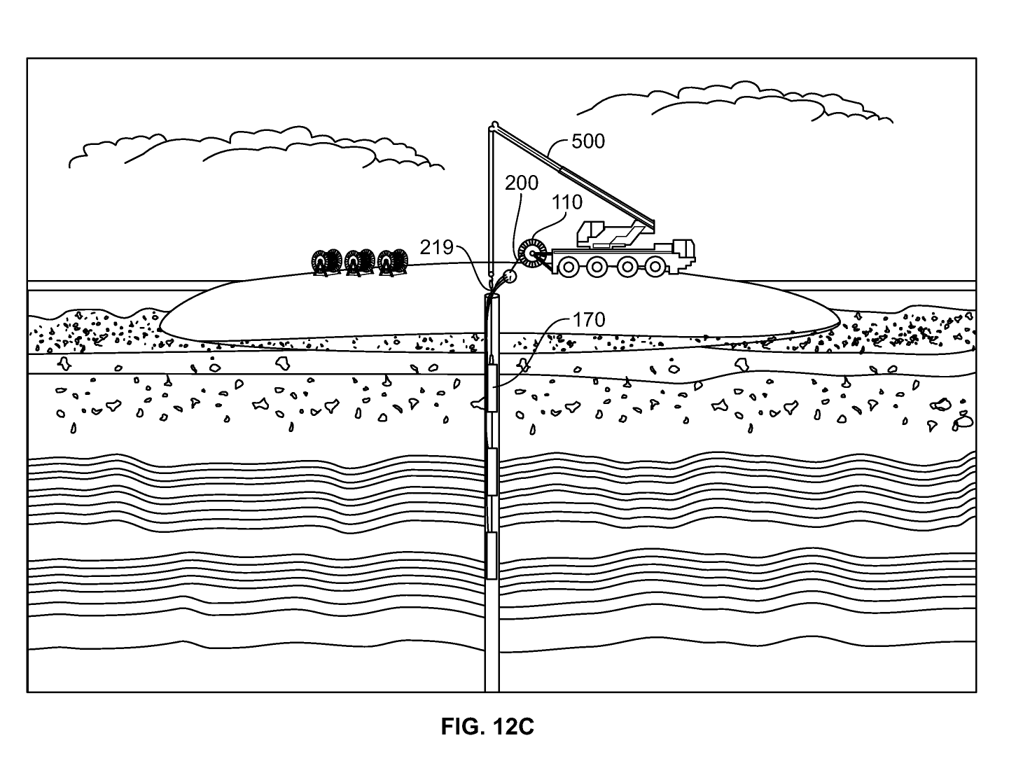

FIGS. 12A through 12C depict images of various stages of the installation process using the present technology. FIG. 12A depicts an in situ three heater array 170 before being lowered into a well bore. Each heater of the array is connected to a single-heater cable, which is connected to a spool or drum. The heater array is next attached to an intermediary strength member 219, which, in turn, is attached to a crane. The crane 500 lowers the in situ heater array 170 into the well bore as depicted in FIG. 12 B. After being lowered to a desired level, the strength member of the multi-composite cable 200, which is depicted wound on a drum in FIG. 12C, is attached to the intermediary strength member 219 that is also attached to the drum 110. Further, each single-heater cable attached to each heater is connected to the multi-composite cable 200. Once the cable 200 is connected to the intermediary strength member 219, the load for the in situ heater array 170 is transferred from the crane 500 to the drum. Accordingly, the drum 110 bears the weight of the in situ heater array. The intermediary strength member 219 can then be disengaged from the crane 500, and the in situ heater array 170 can be lowered to the desired depth by unrolling the cable from the drum. The individual heaters of the in situ heater array 170 also receive the electrical power and fluid through the multi-composite cable 200.

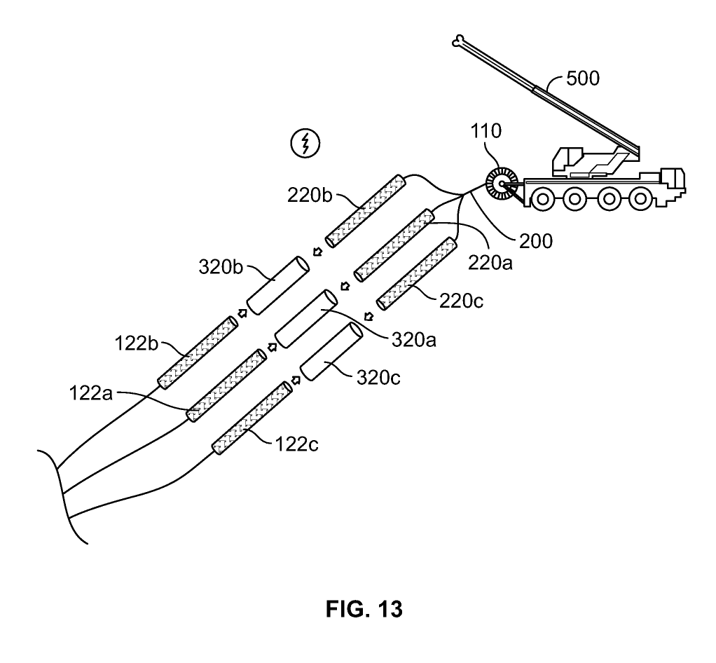

FIG. 13 provides a demonstrative image of how the electrical connections are made from the drum to the individual single-heater cables. The multi-composite cable 200 wound on the drum 110 comprises three electrical conductors (220a, 220b and 220c). Each of the three electrical conductors mate with a connector (320a, 320b and 320c) at an end location. The opposite end of the connectors (320a, 320b and 320c) are mated with another electrical conductor (122a, 122b and 122c, respectively). Each of the conductors 122a, 122b and 122c are part of a separate single-heater cable that delivers electrical power to an individual heater of the in situ heater array.

The present technology also includes alternate systems and methods for connecting the individual heaters to the multi-component cable. For example, in certain embodiments, the single-heater cables may be broken into multiple segments, each segment connected to another segment via a connector or splice apparatus at a position in between heaters of a heater array. For example, in an alternate embodiment to that depicted in FIG. 1, three separate single-heater cables may run to the top heater of the heater array, whereby only one of the single-heater cables is used to deliver fluid and electrical power to the first heater. In this alternate embodiment, the two unused single-heater cables extend below the first heater, and can be connected or spliced to additional single-heater cables that run to the second and third heaters, respectively. Further, the two unused single-heater cables may both run to the second heater, whereby one of the single-heater cables is used to deliver fluid and electrical power to the second heater and the other single-heater cable extends below the second heater for delivery to the third heater. The remaining unused single-heater cable can be connected or spliced to another single-heater cable that runs to the third heater and delivers fluid and electrical power to the third heater. In this manner, the single-heater cables can be kept in proximity to one another before installation, thereby allowing for control of the slack from the heater cables during the installation process.

The present technology has now been described in such full, clear, concise and exact terms as to enable any person skilled in the art to which it pertains, to practice the same. It is to be understood that the foregoing describes preferred embodiments and examples of the present technology and that modifications may be made therein without departing from the spirit or scope of the invention as set forth in the claims. Moreover, it is also understood that the embodiments shown in the drawings, if any, and as described above are merely for illustrative purposes and not intended to limit the scope of the invention. As used in this description, the singular forms “a,” “an,” and “the” include plural reference such as “more than one” unless the context clearly dictates otherwise. Where the term “comprising” appears, it is contemplated that the terms “consisting essentially of” or “consisting of” could be used in its place to describe certain embodiments of the present technology. Further, all references cited herein are incorporated in their entirety.

1) A multi-component composite cable for delivering electrical power and fluid to an in situ heater array for use in an in situ oil production process, said cable comprising:
a. a plurality of conductors for delivering electrical power to an in situ heater array, each of said conductors comprising:
i. a conductive wire; and
ii. a conductor insulation layer that surrounds at least a portion of the conductive wire;
b. a plurality of hoses for transmitting fluid to said heater array;
c. a strength member comprising a heat resistant material; and
d. a cable jacket surrounding at least a portion of said plurality of conductors, said plurality of hoses and said strength member.

2) The multi-component composite cable of claim 1 wherein each of said plurality of conductors further comprises a conductor jacket that surrounds at least a portion of the conductors.

3) The multi-component composite cable of claim 2 wherein each of said plurality of conductors comprises at least one conductor braid layer comprising a fiberglass material.

4) The multi-component composite cable of claim 1, wherein said cable jacket comprises chlorinated polyethylene.

5) The multi-component composite cable of claim 1, wherein the heat resistant material of said strength member is an aramid fiber rope.

6) The multi-component composite cable of claim 1 wherein the strength member comprises a strength member jacket comprising chlorinated polyethylene.

7) The multi-component composite cable of claim 1, wherein said composite cable comprises three conductors and three hoses.

8) The multi-component composite cable of claim 7, wherein said strength member is situated in the center of said composite cable and wherein at least three of the conductors and at least three of the hoses are alternated around the strength member.

9) The multi-component composite cable of claim 1, wherein said conductor insulation layer comprises silicone rubber.

10) The multi-component composite cable of claim 1, wherein said plurality of hoses are electrically non-conductive, have an inner diameter of ⅜ inches, and are rated for use at a pressure of at least 2250 PSI.

11) The multi-component composite cable of claim 1, further comprising at least one electrical connector connected to the end of each of said conductors, and at least one hydraulic connector connected to the end of each hose.

12) A single-heater composite cable for delivering electrical power and fluid to an in situ heater for use in an in situ oil production process, said cable comprising:
a. an electrical conductor wire for delivering electrical power to one in situ heater, said conductors comprising:
i. a conductive wire; and
ii. a conductor insulation layer that surrounds at least a portion of the conductive wire;
b. a hose for transmitting fluid to an in situ heater; and
c. a cable jacket surrounding at least a portion of each of said electrical conductor wire and said hose.

13) A system for delivering electrical power and fluid to an in situ heater array system for use in an in situ oil production process, said system comprising:
a. a multi-component composite cable comprising:
i. a plurality of conductors for delivering electrical power to an in situ heater array;
ii. a plurality of hoses for transmitting fluid to the heater array;
iii. a strength member comprising a heat resistant material; and
iv. a multi-heater cable jacket surrounding said plurality of conductors, said plurality of hoses and said strength member;
b. a plurality of single-heater composite cables for delivering electrical power and fluid from said multi-component composite cable to a heater in the heater array, each said single-heater composite cable comprising:
i. an electrical conductor wire for delivering electrical power to one heater in the heater array,
ii. a hose for transmitting fluid to one heater in the heater array; and
iii. a single-heater cable jacket surrounding said electrical conductor wire and said hose; and
c. a splice protector for protecting a connection between said multi-component composite cable and said plurality of single-heater composite cables.
wherein each of said plurality of single-heater composite cables is connected to at least one conductor and at least one hose of said multi-component cable within said splice protector.

14) A system for heating oil shale comprising the system of claim 13 and an in situ heater array comprising one or more in situ heaters.

15) The system of claim 14, wherein said heater array comprises at least three in situ heaters.

16) A method of assembling an in situ heater array, the heater array comprising a plurality of in situ heaters, said method comprising the following steps:
a. providing a multi-component composite cable comprising:
i. a plurality of conductors for delivering electrical power to the in situ heater array;
ii. a plurality of hoses for transmitting fluid to the in situ heater array;
iii. a strength member comprising a heat resistant material; and
iv. a multi-component cable jacket surrounding at least a portion of said plurality of conductors, said plurality of hoses and said strength member;
b. providing a plurality of single-heater composite cables for delivering electrical power and fluid from said multi-component cable to an in situ heater in the in situ heater array, each said single-heater composite cable comprising:
i. an electrical conductor wire for delivering electrical power to one in situ heater in said heater array,
ii. a hose for transmitting fluid to said one in situ heater in the in situ heater array; and
iii. a single-heater cable jacket surrounding said electrical conductor wire and said hose; and
c. connecting a top portion of the electrical conductor wire of each of said single-heater composite cables with a bottom portion of a conductor of said multi-component composite cable;
d. connecting a top portion of the hose of each of said single-heater composite cables with a bottom portion of a hose of said multi-component composite cable;
e. surrounding the connections between said multi-component composite cable and said single-heater composite cable with a protective housing; and
f. filling said housing with a protective substance.

17) The method of claim 16, further comprising the step of connecting a bottom portion of at least one of said single-heater composite cables with at least one heater.

18) The method of claim 16, wherein said multi-component composite cable is provided wound on a drum.

19) The method of claim 18, wherein a top end portion of said multi-component composite cable is inserted into the center of the drum for connection to a power and/or fluid supply.

20) A method of providing power and fluid to an in situ heater array comprising the steps of:
a. providing a multi-component composite cable comprising:
i. a plurality of conductors for delivering electrical power to the in situ heater array;
ii. a plurality of hoses for transmitting fluid to the in situ heater array;
iii. a strength member comprising a heat resistant material; and
iv. a multi-component cable jacket surrounding at least a portion of said plurality of conductors, said plurality of hoses and said strength member;
b. providing a plurality of single-heater composite cables for delivering electrical power and fluid from said multi-component cable to a heater in the in situ heater array, each said single-heater composite cable comprising:
i. an electrical conductor wire for delivering electrical power to one in situ heater in said heater array,
ii. a hose for transmitting fluid to said one in situ heater in said heater array; and
iii. a single-heater cable jacket surrounding said electrical conductor wire and said hose; and
c. connecting a top portion of the electrical conductor wire of each of said single-heater composite cables with a bottom portion of a conductor of said multi-component composite cable;
d. connecting a top portion of the hose of each of said single-heater composite cables with a bottom portion of a hose of said multi-component composite cable;
e. surrounding the connections between said multi-component composite cable and said single-heater composite cable with a protective housing; and
f. providing electrical power and fluid to one or more in situ heaters in the heater array.

21) A method for producing oil from an oil shale comprising the steps of:
a. providing an in situ heater array comprising a plurality of in situ heaters in a well bore extending through a bitumen deposit;
b. providing a multi-component composite cable comprising:
i. a plurality of conductors for delivering electrical power to the heater array;
ii. a plurality of hoses for transmitting fluid to said heater array; and;
iii. a strength member comprising a heat resistant material; and
iv. a multi-component cable jacket surrounding at least a portion of said plurality of conductors, said plurality of hoses and said strength member;
c. providing a plurality of single-heater composite cables for delivering electrical power and fluid from said multi-component cable to an in situ heater in said heater array, each said single-heater composite cable comprising:
i. an electrical conductor wire for delivering electrical power to a first in situ heater in said heater array,
ii. a hose for transmitting fluid to said first in situ heater; and
iii. a cable jacket layer surrounding at least a longitudinal portion of said electrical conductor wire and said hose; and
d. connecting a top portion of the electrical conductor wire of each of the single-heater composite cables with a bottom portion of a conductor of the multi-component composite cable;
e. connecting a top portion of the hose of each of the single-heater composite cables with a bottom portion of a hose of the multi-component composite cable;
f. connecting a bottom portion of each single-heater composite cable with an in situ heater in said heater array;
g. providing electrical power and fluid to said first in situ heater in said heater array;
h. collecting liquid oil from the bitumen deposit; and
i. transporting the liquid oil from below ground to above ground.
